(19) United States
(12) Patent Application Publication
(10) Pub. No.: US 2006/0131385 A1
(43) Pub. Date: Jun. 22, 2006

(54) Conditional transaction notification and implied approval system

(76) Inventor: Mike Insang Kim, Rancho Santa Margarita, CA (US)

Correspondence Address: Walter T. Kim;Suite 1300, 2030 Main Street, Irvine, CA, 92614, US

(21) Appl. No.: 11/037,729

(22) Filed: Jan. 18, 2005

Related U.S. Application Data
(63) Continuation-in-part of application No. 11/015,597, filed on Dec. 16, 2004.

(51) Int. Cl. G07F 19/00; G06Q 40/00

(52) U.S. Cl. 235/379; 705/44

(57) ABSTRACT

A method and a corresponding system are described for providing conditional notification of transaction requests. The method includes receiving a transaction request which contains information regarding an account requesting a transaction and determining if the transaction request satisfies at least one condition for providing a notification of the transaction request. If at least one condition for providing the notification is satisfied by the transaction request, a transaction notification message is generated and transmitted to a communication device assigned to the requesting account.

### CROSS REFERENCE TO RELATED APPLICATIONS

This application is a continuation-in-part of U.S. patent application Ser. No. 11/015597, entitled “Method and System for Providing Transaction Notification and Mobile Reply Authorization”, filed on Dec. 16, 2004, which is hereby incorporated by reference.

### BACKGROUND OF THE INVENTION

1. Field of the Invention

The present invention generally relates to processing commercial transactions, and in particular, to a system for providing transaction notifications.

2. Description of the Related Art

The number of consumers using the Internet to make online purchases continues to increase. In such credit card transactions, because consumers are making the transactions by inputting information from a remote location, merchants cannot check for picture identification and/or compare the purchaser's signature with a signature on the card to verify that the purchaser is an authorized card user. Moreover, because it is not even necessary to have the physical credit card itself when transactions are made from remote locations, a credit card thief may be able to make an unauthorized charge simply by finding a sales slip with someone else's account number and expiration date. Fraudulent and unauthorized use of credit cards is a concern for all those involved in credit card transactions, including the card users, banks and financial institutions that provide credit cards. It has been estimated that credit card fraud losses may be in the range of billions of dollars a year, which is ultimately paid by the consumers through higher credit card charges and higher purchase prices.

Systems employing smart cards have been disclosed. Smart cards include a microprocessor with a memory element embedded within a physical card or device and may contain various information, such as the amount of funds in a particular account, a transaction history, account numbers and other customer data. Although various smart card systems have been proposed which attempt to provide security against fraudulent transactions, they do not address the problem of fraudulent use of conventional transaction cards (e.g., credit or debit cards having non-secure magnetic stripe data memories). Furthermore, there are a number of disadvantages associated with smart card systems. For one thing, smart cards require a smart card reader which is specifically configured to read the smart cards. Therefore, authentication or security features of smart card systems may not be performed when such smart card readers are unavailable.

### BRIEF SUMMARY OF EMBODIMENTS THE INVENTION

Described herein are various embodiments of a system and a corresponding method for providing conditional notification of transaction requests to authorized cardholders. The system is coupled to receive a transaction request which contains information regarding an account requesting a transaction. Once a transaction request has been received, the system determines if the transaction request satisfies at least one condition for providing a notification of the transaction request. If at least one condition for providing the notification is satisfied by the transaction request, a transaction notification message is generated and transmitted to a communication device preassigned to the requesting account.

According to an embodiment, the system includes the functionality to enable a card issuer to set conditions for providing transaction notifications. The same notification conditions may be applied to all or a group of accounts issued by the card issuer. Alternatively, a different set of notification conditions may be set on individual account basis. A notification condition may specify a transaction amount which triggers the notification requirement. Another notification condition may be used to trigger the notification requirement based on the geographical location of the merchant with respect to the location of the authorized cardholder (e.g., billing address of the cardholder). Another notification condition may be used to trigger the notification requirement if it is determined that the transaction was initiated online or from a remote location. Another notification condition may be used to trigger the notification requirement based on an amount of time lapsed since the most recent transaction request by the requesting account. Another notification condition may be used to trigger the notification requirement based on the determination of whether the requesting account has previously conducted a transaction with the same merchant submitting the transaction request.

According to an embodiment, the system includes the functionality to examine transaction requests submitted by merchants, payments servers and/or transaction computers and determine if predefined conditions for providing a transaction notification are satisfied. This may be accomplished by identifying the notification conditions applicable to the account requesting the transaction and determining if information contained in the transaction request satisfies the applicable conditions. The system may include the functionality to determine whether a notification needs to be provided by comparing the transaction amount indicated in the transaction request with a predetermined threshold amount. The system may also include the functionality to determine whether the notification requirement is triggered based on the location of the merchant submitting the transaction request. The system may further include the functionality to determine if the notification requirement is triggered based on information indicating whether the transaction is made online and/or from a remote location. The system may further include the functionality to determine if the notification requirement is triggered based on an amount of time lapsed since the most recent transaction request made by the requesting account. The system may further include the functionality to determine if the notification requirement is triggered based the determination of whether the requesting account has previously conducted a transaction with the same merchant submitting the transaction request.

According to an embodiment, the system includes the functionality to automatically assume that the recipient of the transaction notification message is approving the transaction request if the recipient has not replied to the message within a predetermined time. When a transaction request is received, the system generates and transmits a transaction notification message to the phone number of the mobile device assigned to the requesting account. Once the notification message has been transmitted, the system may wait a defined period of time to receive a reply message from the recipient of the notification message and assume that the recipient of the notification message is approving the transaction request if a reply message is not received within the reply waiting period. In one embodiment, the system includes the functionality to record the time at which the notification message was transmitted and determine the lapse of the reply waiting period based on the recorded time. At the end of the reply waiting period, the system may determine whether there has been a reply to the notification message and assume approval of the transaction if the recipient of the message fails to reply to the notification message within the reply waiting period.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 shows a block diagram of a system for performing secure online transactions according to an embodiment of the present invention.

FIG. 2 shows a block diagram of a transaction authorization server coupled to a cardholder information database according to an embodiment of the present invention.

FIG. 3 shows a flowchart diagram of a process for processing an online transaction request according to an embodiment of the present invention.

FIG. 4 shows a flowchart diagram of a process for validating and analyzing reply messages received from mobile devices according to an embodiment of the present invention.

FIG. 5 shows a flowchart diagram of a process for enabling selection of conditions for triggering an execution of a mobile reply authorization process according to an embodiment of the present invention.

FIG. 6 shows a block diagram of a transaction notification program executed by a transaction authorization server according to an embodiment of the present invention.

FIG. 7 shows a flowchart diagram of a process for providing conditional transaction notification according to an embodiment of the present invention.

FIG. 8 shows a flowchart diagram of a process for processing a transaction request where a recipient has not replied to a transaction notification message according to an embodiment of the present invention.

FIG. 9 shows a flowchart diagram of a process for processing a transaction request where a recipient has not replied to a transaction notification message according to another embodiment of the present invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known hardware and software components, structures and techniques have not been shown in detail in order to avoid obscuring embodiments of the present invention.

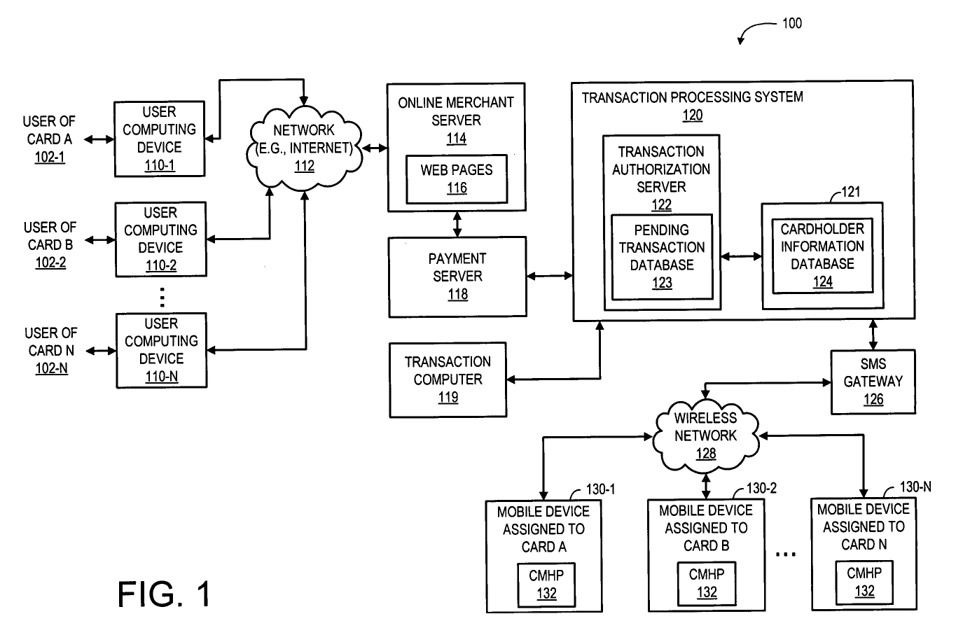

Shown in FIG. 1 is a simplified representation of a system 100 to facilitate secure sales transactions in accordance with an embodiment of the present invention. In this system, credit card users 102-1 through 102-N can connect with an online merchant server 114 via a network 112 using their user computing devices 110-1 through 110-N. The network 112 may include, for example, the Internet, a virtual private network (“VPN”), a wide area network (“WAN”) and/or a wireless network to enable data transmission between the user devices 110 and merchant server 114. The user computing devices 110 can be any suitable device capable of establishing communication with the network, including personal computers, laptop computers, and/or wireless communications devices (e.g., cellular phones, personal digital assistants (“PDAs”)).

The merchant server 114 may be operated by a merchant offering various goods and/or services and may be an application server, a web server or any other type of server capable of offering electronic commerce services over the Internet. A card user 102 may use Web browser software running on the user's computing device to access and interact with Web pages 116 and other information provided by the merchant server 1114 in which various types of goods and/or services are described and/or shown. To make a purchase, a card user 102 may provide the merchant 114 with transaction information required for conducting a transaction, such as, for example, the account number and expiration date of a transaction card. In one embodiment, the transaction card used is a credit or debit card having a non-secure magnetic stripe data memory.

The merchant server 114 may forward the transaction information provided by the card user and information about the purchase, such as price, item description and date of transaction to a payment server 118. The payment server 118 may then generate a transaction request based on the transaction information received from the merchant server and forward the transaction request to a transaction processing system 120 that handles transactions for the specific transaction card. The system 120 processes the transaction request and returns an authorization granted or denied message to the payment server 119. The payment server 119 forwards the message from the system 120 to the merchant server 114 and based on the message, the merchant server 114 may complete the purchase requested by the card user.

In an embodiment, the transaction processing system 120 is also configured to receive transaction requests from a transaction computer 119. The transaction computer 119 may be any special purpose device capable of handling transactions, including but not limited to automatic teller machines (“ATMs”), point of sale (POS) terminals and credit card terminals.

Although only one merchant server 114, only one payment server 118 and only one transaction computer 119 are illustrated in FIG. 1, it should be understood that any number of merchant servers, payment servers and transaction computers 119 may be coupled to the transaction processing system 120 to submit transaction requests and receive transaction approval or denial information. The communication between the payment server 118 and the system 120 may be established using any suitable communication means, such as the Internet, the public switched telephone network, dedicated communication lines, or a combination thereof. Similarly, the communication between the transaction computer 119 and the system 120 may be established using any suitable communication means, such as the Internet, the public switched telephone network, dedicated communication lines, or a combination thereof.

The transaction processing system 120 may be maintained and operated by a card provider, a bank, a financial institution or other types of institutions. The system 120 may include one or more servers coupled to one or more databases. In the illustrated embodiment, the system 120 includes a transaction authorization server 122 which is in communication to receive transaction requests. The server 122 enables a card provider to notify its cardholder of pending transaction requests so that unknown or fraudulent charges can be immediately identified. Additionally, the server 122 enables the card provider to obtain direct authorization from cardholders to ensure that the transaction requests are being made by the authorized cardholders.

A storage device 121 is in communication with the server 122 for storing cardholder information database 124. The cardholder information database 124 may include account information of each cardholder such as the cardholder identification, account number, billing address, phone numbers and other information such as the credit limit and account balance associated with each account. When an applicant applies to open an account (e.g., credit card account) with a card provider, the card provider may request that the applicant provide a phone number of a mobile device to which the applicant desires to receive authorization request messages. The phone number information is associated with the account number and stored in the cardholder information database 124.

The transaction processing system 120 is coupled to a wireless network 128 via a data transport interface, such as Short Message Service (“SMS”) gateway 126. In one embodiment, text messages between the system 120 and mobile devices 130-1 through 130-N are transmitted and received using SMS text messaging. In this regard, SMS gateway 126 facilitates communication between the system 120 and the wireless network using SMS protocol. Although SMS text messaging protocol is used in one embodiment to send authorization request messages to and receive reply messages from mobile devices, other types of communication protocol may be employed to transmit and receive the messages, including protocols that can convey sound, data, images or any combination of thereof. Wireless network 128 may be a Global System for Mobile communications (“GSM”) network or any other appropriate network that facilitates wireless communication to and from mobile devices 130-1 through 130-N.

Each mobile device 130 is preferably a wireless communication device capable of sending and receiving messages over a wireless network and displaying the messages to a user. Mobile device can be cellular phones, personal digital assistants (PDAs) and/or other types of mobile devices. The mobile device 130 may include a client message handling program (“CMHP”) 132 that enables the user to access the authorization request message sent by the server 122 and to respond to the authorization request message by generating a reply message (e.g., approval or denial of the transaction). In one embodiment, the CMHP 132 executed by the mobile device is a text messaging program which enables the user to generate a reply message by attaching a response (indication of approval or denial) to at least a portion of the authorization request message.

In another embodiment, the CMHP 132 executed by the mobile device 130 is a message handling application which is specifically configured to handle authorization request messages from the server 122 and to generate and transmit reply message to the server 122. In one implementation, the CMHP 132 recognizes the format of authorization request messages sent from the server 122. Similarly, the message analyzing program 40 provided on the server 122 recognizes the format of reply messages generated by the CMHP 132. The CMHP 132 executed by the mobile device 130 includes the functionality to display transaction information included in an authorization request message to the user, which may include (i) the merchant name, (ii) the date of the transaction, (iii) the merchant location, and (iv) the purchase amount. Another function provided by the CMHP 132 is to prompt the user to input a response (e.g., approval or denial of the transaction) by pressing designated buttons on the mobile device. In one implementation, one of the buttons on the mobile device is designated for accepting the charge and another one of the buttons is designated for declining the charge. Accordingly, the user may respond to the authorization request message by simply pressing a button that corresponds with a desired response. Based on the user's input, the CMHP 132 generates a reply message which includes information regarding whether or not the user of the mobile device approves the transaction and sends the reply message to the system 120.

In accordance with one embodiment, the transaction processing system 120 facilitates detection and prevention of fraudulent credit card charges without employing “smart card” type device embedded within a transaction card or incorporated within a message handling mobile device. Accordingly, in one embodiment, the system 100 does not require that the message handling mobile devices contain or have access to information regarding credit card account numbers or other credit card related information regarding cardholders.

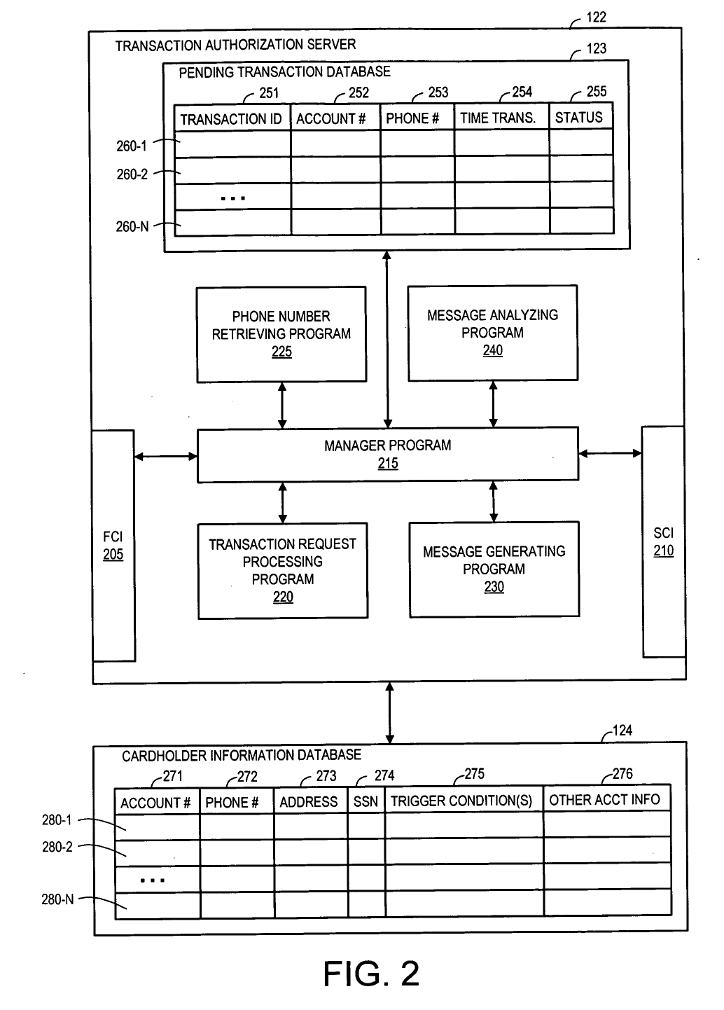

FIG. 2 shows a simplified representation of a transaction authorization server coupled to a cardholder information database according to an embodiment of the present invention. The transaction authorization server 122 includes a first communication interface (“FCI”) 205 to establish communication with payment servers 118 and/or transaction computers 119 and a second communication interface (“SCI”) 210 to establish communication with mobile devices 130. The server 122 further includes a manager program 215, a transaction request processing program 220, a phone number retrieving program 225, a message generating program 230, a message analyzing program 240 and a pending transaction database 123 accessible by programs 215, 220, 225, 230 and 240. Although the software programs 215, 220, 225, 230 and 240 are shown as separate software programs, it should be noted that any suitable arrangement of software components can be employed to provide the functionalities described herein. For example, software programs 215, 220, 225, 230 and 240 can be integrated into one or more software applications executed by the server 122. Further, in various embodiments, hard-wired circuitry may be used in place of or in combination with software instructions to implement the functionalities described herein. Thus, the embodiments of the present invention are not limited to any specific combination or arrangements of hardware circuitry and software components.

The pending transaction database 123 is used to maintain records of pending transaction requests, which are waiting for a reply from cardholders. In one embodiment, the pending transaction request records are generated from transaction requests and each record includes a transaction identification code or number (“transaction ID”) uniquely identifying the transaction. More specifically, in the illustrated embodiment, each record 260-1 through 260-N of the database 123 includes (i) a Transaction ID column 251 to store a transaction ID that has been assigned to a corresponding transaction request, (ii) an Account # column 252 to store an account number requesting the transaction request, (iii) a Phone # column 253 to store a phone number of a mobile device associated with the account number, (iv) a Time of message Transmission column 254 to record the time when the authorization request message was transmitted, and (v) a Status column 255 to contain information relating to the status of the transaction request, such as waiting for reply, approval reply received, denial reply received, invalid reply received, etc. Other information pertaining to a transaction may also be included in the database 123, such as date and time of the requested transaction, merchant name, merchant location, description of the purchase item, purchase amount and/or other relevant information.

As shown in FIG. 2, the transaction authorization server 122 is in communication with the cardholder information database 124 to access account information required to process transaction requests. The cardholder information database 124 includes a number of records 280-1 through 280-N, each record containing information relating to an account issued by a card provider. In one embodiment, each record 280 of the cardholder information database 124 contains (i) an Account # column 271 to store an account number for a transaction card, (ii) a Phone # column 272 to store a phone number of a mobile device assigned to receive authorization request messages, (iii) an Address column 273 to store a billing address associated with the account number, (iv) a SSN column 274 to store a social security number of the account holder, (v) a Trigger Condition(s) column 275 to store information relating to condition(s) for triggering a mobile reply authorization requirement, and (vi) an Other Acct Info column 276 to store other information relating to the account. Although FIG. 2 shows that the phone number information 272 is stored in the cardholder information database 124 along with other account information, it will be appreciated that the phone number information may be stored in another database separate from the cardholder information database.

The manager program 215 provided on the transaction authorization server 122 is configured to manage processing of transaction requests and to manage messages sent and received from mobile devices. The phone number retrieving program 225 is configured to identify a phone number of a mobile device assigned to receive an authorization request message based on the account number information included in a transaction request by searching through the cardholder information database 124. The transaction request processing program 220 is configured to perform various functions necessary for processing a transaction request, such as determining the accuracy of the information contained in the transaction request, determining the status of the account (e.g., valid account or invalid account), and/or determining if the purchase amount is within the credit limits. The message generating program 230 is configured to generate an authorization request message which provides notification of a pending transaction request and requests a reply indicating either an approval or denial of the transaction. The message analyzing program 240 provided on the server 122 is configured to examine the reply message to determine its validity and to determine whether or not the transaction is approved by a user of the mobile device based on the content of the reply message.

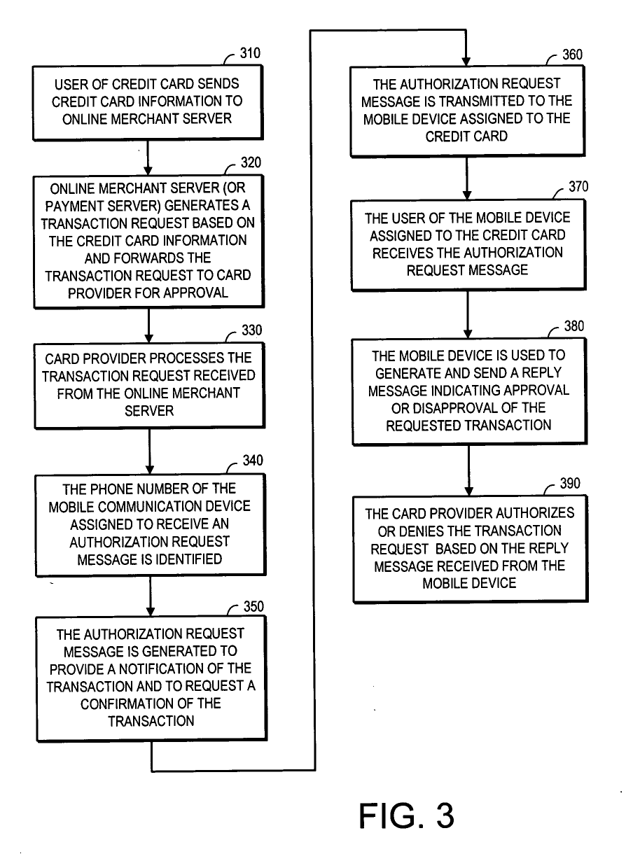

FIG. 3 shows general operations involved in processing an online card transaction according to an embodiment of the present invention. A user 102 of a credit card connects to an online merchant server 114 via a computing device 110, which prompts the user to input information required to carry out an electronic credit card transaction, such as the account number and expiration date of the credit card and optionally other personal information (e.g., the name, social security number, date of birth and billing address of the authorized cardholder). Thus in block 310, the user 102 inputs the requested data into the user's computing device and sends the credit card information to the online merchant server 114 via a network connection (e.g., Internet).

It should be noted that because of transaction notification and authorization features provided by various embodiment of the present invention, some of the personal or sensitive information currently required to carry out a conventional online credit card transaction may be omitted, such as the name of the credit card holder, the billing address, the social security number and date of birth of the cardholder and the like. In one embodiment, only information required by the merchant server to carry out an online credit card transaction using the system of the present invention is the account number of a transaction card. In another embodiment, the server 122 will process a transaction request without requiring submission of one or more of the following information: (i) the cardholder's social security number, (ii) the cardholder's date of birth, (iii) the cardholder's phone number, and (iv) the cardholder's billing address.

The information send by the card user 102 is collected by the online merchant server 114 and based on this information the online merchant server 114 or the payment server 118 generates a transaction request and forwards the transaction request to the system 120 for approval in block 320. Then in block 330, the transaction request processing program 220 on the server 122 is used to perform an initial processing of the transaction request received from the online merchant server 114. The transaction processing system 120 has an access to a cardholder information database that contains account information relating to each of its issued credit cards, such as the credit card numbers, expiration dates, billing addresses and credit limits of its cardholders. The information contained in the transaction request is compared with information included in the database to ensure that the requesting credit card is a valid account issued by the card provider and that the amount of the transaction is within the card user's credit limit.

If the requesting account is a valid account issued by the card provider, the server 122 may perform a mobile reply authorization process (“MRAP”) to send a notification of the transaction and request authorization from the cardholder. The MRAP will be described more in detail with respect to blocks 340 through 390. In one embodiment, the MRAP is used to provide a notification of a pending transaction in the form of a text message to a mobile device of a cardholder and to obtain a reply message in a text message from the same mobile device indicating either approval or denial of the transaction. The MRAP begins in functional block 340 with the phone number retrieving program 225 on the server 122 retrieving a phone number of a mobile device assigned to the requesting account by searching the cardholder information database 124. In one embodiment, the phone number retrieving program 225 functions as a search engine and the information is arranged in the cardholder information database 124 such that an account number search will locate the relevant phone number designated to handle authorization request messages for the account.

To provide a notification of the pending transaction and to request a confirmation of the transaction directly from a user of the assigned mobile device, the message generating program 230 on the server 122 is used to generate an authorization request message based on the information contained in the transaction request in block 350. The authorization request message may be in a form of a text message containing one or more of the following information: (i) the transaction ID, (ii) the date of the transaction, (iii) the purchase description, (iv) the purchase amount, (v) the name of the merchant, and (vi) the location of the merchant. Then in block 360, the server 122 transmits the authorization request message to the phone number of the mobile device assigned to the requesting account via a wireless network 128.

Once the authorization request message has be received by the mobile device in block 370, the user of the mobile device 130 can use the text messaging program 132 to access the authorization request message to verify the transaction information. The text messaging program 132 executed on the mobile device 130 may prompt the user to input a response (e.g., approval or denial of the transaction) by pressing designated buttons on the mobile device. Based on the user's input, the text messaging program 132 generates a reply message which includes information regarding whether or not the user of the mobile device approves the transaction. In addition, the reply message may also contain (i) the transaction ID included in the original authorization request message, and (ii) other information pertaining to the transaction, such as the description of the purchase, purchase amount, date of the purchase and name of the merchant.

In block 380, the reply message generated by the mobile device is transmitted to the server 122. When the reply message is received by the server 122, the message analyzing program 240 on the server 122 is used to determine its validity and to determine if the requested transaction is approved or denied by the mobile device user. In block 390, if the reply message approves the transaction, the system 120 will send an authorization granted message to the online merchant server 114 via the payment server 118 indicating that the merchant is authorized to accept this credit card transaction. Otherwise if the reply message denies the transaction, the system 120 is configured to send an authorization denied message instructing that the payment server 118 and the merchant 114 to deny this credit card transaction. In addition, whenever a reply message denying a transaction is received by the server 122, the card provider may immediately suspend the corresponding credit card account to prevent any further fraudulent use.

By utilizing a reply message received from a mobile device assigned by an authorized cardholder, the number of fraudulent use of the credit card can be significantly reduced since fabricating such reply message by a fraudulent user from the same mobile device phone number may be difficult, if not impossible, without actually possessing the mobile device itself. Typically, fraudulent use of a credit card occurs when the credit card is lost, stolen or the account number is compromised. The transaction processing system 120 according to embodiments of the present invention requires that a person attempting to make an unauthorized charge to possess both the credit card and the mobile device of the authorized cardholder. Since most people know immediately when they have lost their mobile devices, the mobile device designated for transmitting an authorization reply message will not be readily available to a thief who has possession of either the physical credit card or the account number of a credit card. Furthermore, because the reply message serves to authenticate the card user, it may not be necessary to verify the identity of the card user during each sales transaction, for example, by checking picture identification and/or comparing the purchaser's signature. This may advantageously save time for the card user and the merchant.

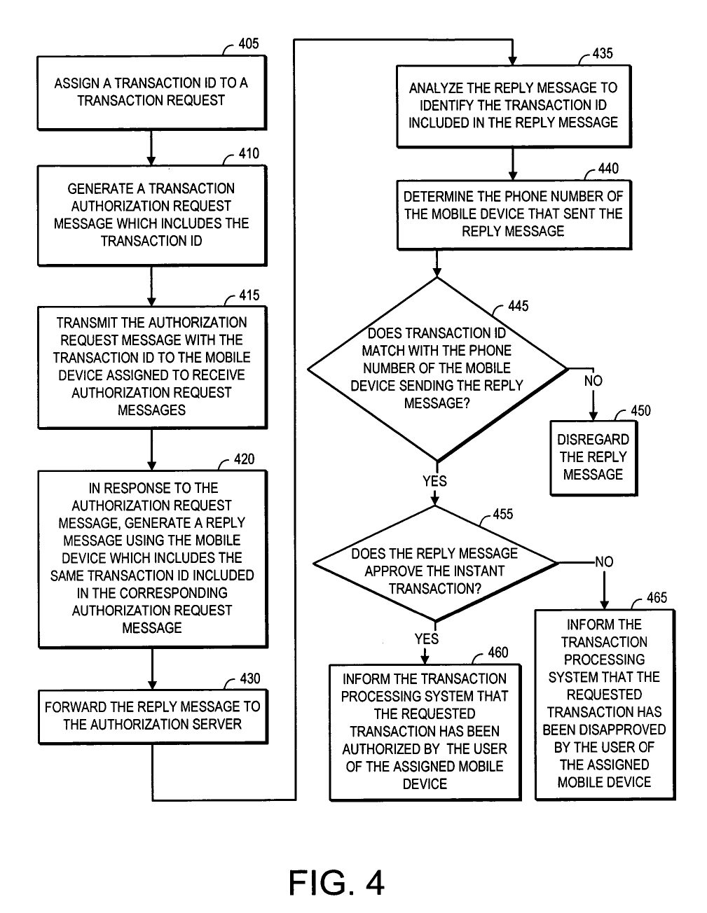

FIG. 4 shows general operations involved in validating and analyzing reply messages received from mobile devices according to an embodiment of the present invention. During the processing of each individual transaction request, a transaction ID may be assigned to each respective transaction request by the transaction processing system 120 for the purpose of identifying each individual transaction request. In one embodiment, the transaction ID assigned to each respective transaction request is used to identify authorization request messages sent to mobile devices and the same transaction ID is used to identify reply messages returned from the mobile devices. In block 405, a transaction ID is assigned to a transaction request before an authorization request message is generated. In block 410, the message generating program 230 on the server 122 is used to generate an authorization request message which includes the transaction ID. Once the authorization request message has been generated, the server 122 sends the message with the transaction ID to the mobile device associated with the requesting account in block 415. In response to the authorization request message, the user of the mobile device may use a software program on the mobile device to generate a reply message, which automatically includes in the reply message the same transaction ID included in the corresponding authorization request message in block 420.

The reply message is sent to the transaction authorization server 122 and the server 122 uses the message analyzing program 240 to determine the transaction ID included in the reply message in block 435. At the same time, the server 122 determines the phone number of the mobile device that sent the reply message in block 440. Based on the information determined in 435 and 440, the message analyzing program 240 determines if the reply message has been returned by the intended mobile device. More specifically, the message analyzing program 240 determines if the transaction ID specified in the reply message properly corresponds with the phone number of the mobile device sending the reply message in block 445.

This may be accomplished, in one embodiment, by accessing the pending transaction database 123 which includes records of pending transaction requests. Each pending transaction record includes, among other things, the transaction ID assigned to each transaction request and the phone number of the mobile device designated to receive the authorization reply message. Accordingly, the message analyzing program can determine if the proper mobile device sent the reply message by comparing the phone number of the mobile device sending the reply message with the phone number associated with the record (retrieved from the pending transaction database 123) having the same transaction ID as specified in the reply message in the pending transaction database 123.

If the phone number of the mobile device sending the reply message does not match with the transaction ID (block 445, no), this means that the reply message was sent from an improper mobile phone and the reply message will be disregarded in block 450. On the other hand, if the phone number of the mobile device sending the reply message does match with the transaction ID (block 454, yes), this means that the reply message was received from the proper mobile device and the reply message is further analyzed to determine whether or not the user of the mobile device has approved the transaction request in block 455. Based on the content of the reply message, if the message analyzing program 240 determines that the user has approved the transaction (block 455, yes), the transaction authorization server inform the transaction processing system 120 that a proper authorization has been received from the authorized cardholder in block 460. Otherwise, if the message analyzing program 240 determines that the user has denied the transaction (block 455, no), the authorization server 122 will send a message to the transaction processing system 120 indicating that the authorized cardholder has denied the transaction request in block 465.

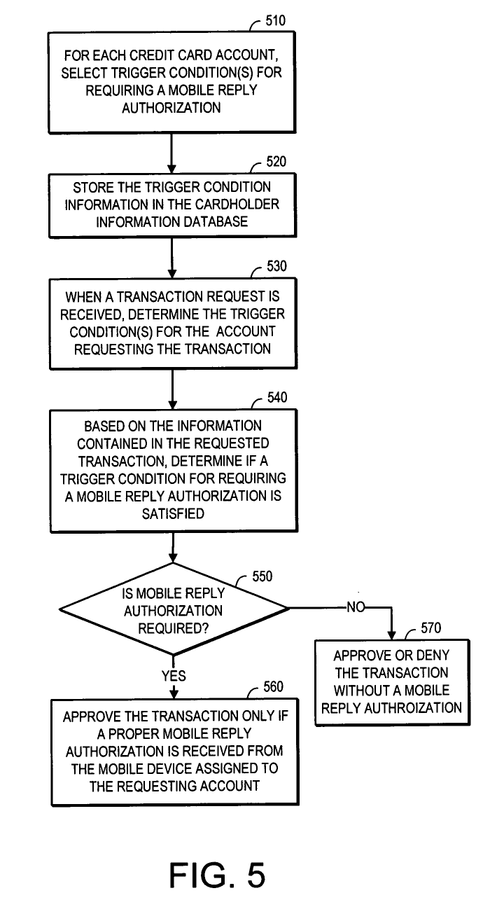

In an embodiment, the server 122 provides a card provider and/or a card holder with the ability to select one or more conditions for triggering an execution of the mobile reply authorization process (“MRAP”) during processing of a particular transaction. FIG. 5 shows general operations of enabling selection of trigger conditions according to an embodiment of the present invention. In one embodiment, the transaction authorization server 122 may choose not to perform the MRAP for certain transaction requests that satisfy the selected trigger conditions. For example, in a case where a cardholder desires to avoid using the MRAP in transactions involving less than certain purchase amount (e.g., $50), the server 122 can be configured to require performance of the MRAP only when transaction requests involve an amount greater than threshold amount. In such case, any transactions involving an amount less than the threshold amount will not require performance of the MRAP.

In block 510, a card provider and/or a cardholder may select one or more trigger conditions for requiring the MRAP. The card provider may choose one or more trigger conditions based on attributes of the account, such as, a credit limit on the account and/or the transaction history of the account. Other trigger conditions may be based on one or more of the following transaction attributes: (i) the type of purchase item (e.g., not requiring MRAP for routine transactions such as gasoline purchases), (ii) the merchant location (e.g., requiring MRAP for transactions involving merchants located in a different state as the cardholder), and/or (iii) the type of transaction (e.g., requiring MRAP for online credit card transactions).

In block 520, the trigger condition information 275 is associated with a corresponding account number and stored in the cardholder information database 124. When a transaction request is received, the transaction processing system 120 retrieves trigger condition information 275 for the requesting account from the cardholder information database 124 in block 530. Then in block 540, the transaction processing system 120 determines if one of the trigger conditions for requiring a mobile reply authorization is satisfied based on the information contained in the transaction request. This may be accomplished by comparing the trigger conditions with appropriates field contained in the transaction request. If the transaction processing system 120 determines that a mobile reply authorization is required (block 550, yes), the transaction authorization server 122 will generate an authorization request message and forward the message to the mobile device assigned to the account requesting the transaction. In this regard, in block 560, the transaction processing system 120 will approve the transaction only if a proper mobile reply authorizing the transaction (e.g., via a reply message) is received from the mobile device assigned to the requesting account. If the card provider determines that a mobile reply authorization is not required (block 550, no), the transaction processing system 120 may approve the transaction without an authorization reply from the cardholder's mobile device if other conditions (e.g., the purchase amount is within the credit limit) for approving the transaction request is satisfied in block 570.

Although the system described above allows card users to engage in online transactions with merchant servers, it should be appreciated that the system described herein may be used by card users conducting offline transactions by communicating directly with sales agents working for merchants either face-to-face or using communication devices (e.g., wired or wireless communication device) to exchange the necessary information to carry out sales transactions. In such cases, the sales agents may manually enter the information provided by the card users into the merchant system, which will generate and sent the transaction requests to the transaction processing system of the card provider. Thus, the embodiments of the present invention are not limited to online transactions, but rather, the embodiments can be used with offline merchants accepting transaction card payments. Furthermore, as shown in FIG. 1, the transaction processing system 120 can be used to process transaction requests from the transaction computer 119, such as automatic teller machines (ATMs), point of sale (POS) terminals, credit card terminals and the like.

In one embodiment, the phone number of the communication device transmitting the reply message serves as a numerical signature and/or an explicit authorization from the authorized cardholder. Thus, when a reply message is received, the transaction authorization server checks the phone number of the communication device transmitting the reply message and determines if the same phone number is associated with the account requesting the transaction. If the reply message is received from a proper phone number, the transaction authorization server uses the phone number as a numerical signature for authorizing the transaction and keeps a record of the reply message along with a record of the phone number transmitting the reply message as an evidence that the transaction request was explicitly authorized by the cardholder's communication device.

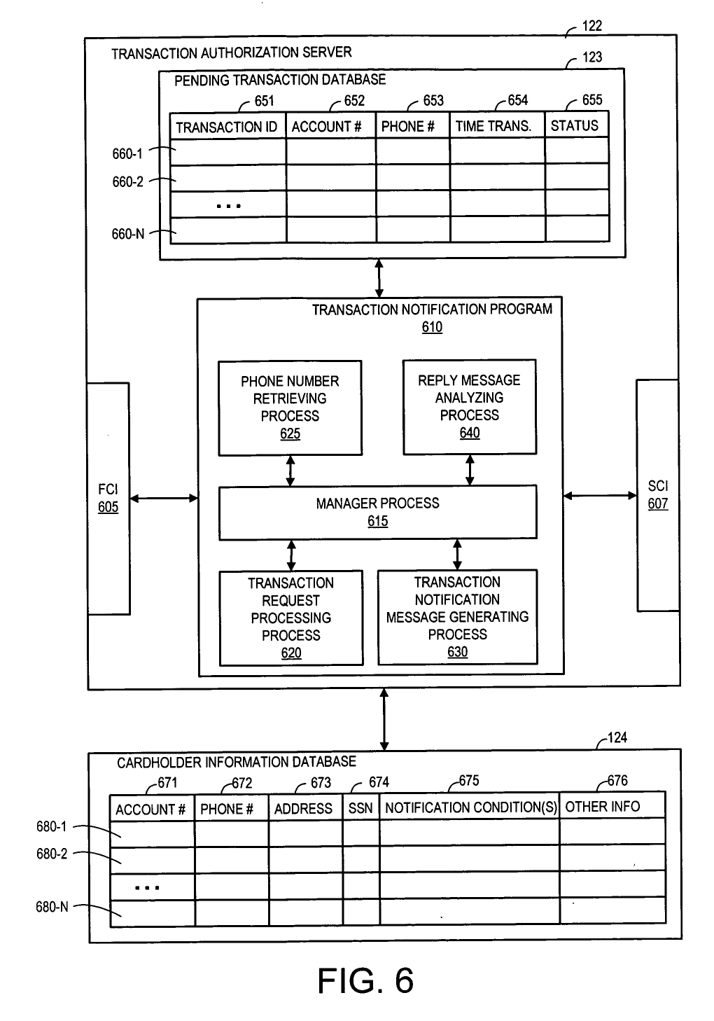

Shown in FIG. 6 is a transaction notification program incorporated within a transaction authorization server according to an embodiment of the present invention. In one embodiment, the transaction authorization server is configured to specify one or more conditions for providing a transaction notification and associate the notification conditions in various combinations to all or a set of accounts issued by a card issuer. In response to receiving a transaction request, the transaction authorization server is configured to recognize one or more notification conditions associated with the account requesting the transaction and determine if at least one of the notification conditions is satisfied based on the information contained in the transaction request. If it is determined that a transaction notification is required, the transaction authorization server is configured to generate and transmit a transaction notification message to a communication device assigned to received transaction notification messages for the requesting account.

In the illustrated embodiment, the transaction authorization server 122 includes a first communication interface (“FCI”) 605 to receive transaction requests and a second communication interface (“SCI”) 607 to establish communication with mobile devices via a wireless network. The server 122 executes, among other programs, a transaction notification program 610 to provide conditional transaction notifications. Also included in the server 122 is a pending transaction database 123 which is accessible by the notification program 610. The transaction notification program includes a manager process 615, a transaction request processing process 620, a phone number retrieving process 625, a transaction notification message generating process 630 and a reply message analyzing process 640. Although the processes 615, 620, 625, 630 and 640 are shown as separate software processes contained within a single application program, it should be noted that any suitable arrangement of software components can be employed to provide the functionalities described herein. Further, in various embodiments, hard-wired circuitry may be used in place of or in combination with software instructions to implement the functionalities described herein.

The pending transaction database 123 is used to maintain records of pending transaction requests, which are waiting for a reply from cardholders. In one embodiment, at least a portion of the information contained in the pending transaction request records are generated from transaction requests. In the illustrated embodiment, each record 660-1 through 660-N of the database 123 includes (i) a Transaction ID column 651 to store a transaction identification code or number (“transaction ID”) that uniquely identifies the transaction, (ii) an Account # column 652 to store an account number requesting the transaction request, (iii) a Phone # column 653 to store a phone number of a mobile device assigned to receive transaction notification messages, (iv) a Time of message Transmission column 654 to record the time when the transaction notification message was transmitted, and (v) a Status column 255 to contain information relating to the status of the transaction request, such as waiting for reply, approval reply received, denial reply received, invalid reply received, etc. Other information pertaining to a transaction may also be included in the database 123, such as date and time of the requested transaction, merchant name, merchant location, description of the purchase item, purchase amount and/or other relevant information.

Coupled to the transaction authorization server 122 is a cardholder information database 124 which contains account information required to process transaction requests. The cardholder information database 124 includes a number of records 680-1 through 680-N, each record containing information relating to an account issued by a card provider. In the illustrated embodiment, each record 680 of the cardholder information database 124 contains (i) an Account # column 671 to store an account number for a transaction card, (ii) a Phone # column 672 to store a phone number of a mobile device assigned to receive transaction notification messages, (iii) an Address column 673 to store a billing address associated with the account number, (iv) a SSN column 674 to store a social security number of the account holder, (v) Notification Condition(s) column 675 to store information relating to condition(s) for providing transaction notifications, and (vi) an Other Acct Info column 676 to store other information relating to the account. Although FIG. 6 shows that the phone number information 672 and notification condition information 675 is stored in the cardholder information database 124 along with other account information, it will be appreciated that the phone number information and notification condition information may be stored in another database separate from the cardholder information database or in other records separate from the cardholder account records.

The manager process 615 of the transaction notification program 610 manages processing of transaction requests and handles notification messages sent and received from mobile devices. Also included in the transaction notification program 610 is a phone number retrieving process 625 which is configured to identify a phone number of a mobile device assigned to receive transaction notification messages. The retrieving process may be accomplished based on the account number information included in a transaction request by searching through the cardholder information database 124. The transaction request processing process 620 is configured to perform various functions necessary for processing a transaction request, such as determining the accuracy of the information contained in the transaction request, determining the status of the account (e.g., valid account or invalid account), and/or determining if the purchase amount is within the credit limits. Also included in the transaction notification program 610 is a transaction notification message generating program 630 to generate text messages providing notification of a pending transaction request and requests a reply if the information contained in the notification message is not accurate or if the transaction is unauthorized. Also included in the transaction notification program 610 is a reply message analyzing program 640 to examine reply messages sent by recipients of notification messages to determine their validity and to determine whether or not the transactions are approved or denied by users of the receiving mobile devices based on the content of the reply messages. In accordance with one embodiment, in certain cases, the recipient of the notification message does not need to reply to the notification message in order to complete the transaction request. Instead, in one embodiment, if the recipient of the notification message does not response within a predetermined time, the program 610 assumes credit card holder's approval of the transaction.

In one embodiment, a notification of a direct deposit and/or an automatic deposit to an account (e.g., bank's checking account and/or savings account) is provided via a text message to a mobile device assigned to receive notification messages for the account getting the deposit. This enables bank customers to immediately know when funds are available in their bank accounts for immediate purchases or payments. For example, in certain cases, it may be useful to know when pay checks are automatically deposited to their bank accounts so that urgent purchases or payments can be timely made. In one embodiment, the transaction notification program incorporated within the transaction authorization server may be configured to carry out this functionality. More specifically, in response to receiving a direct deposit and/or an automatic deposit for an account, the transaction notification program can identify the phone number of the mobile device assigned to receive notification messages for the account receiving the deposit and generate and transmit a deposit notification message to the assigned mobile device. The deposit notification message may contain the following information: (1) the source of the deposit, (2) the time of the deposit, and (3) the deposit amount.

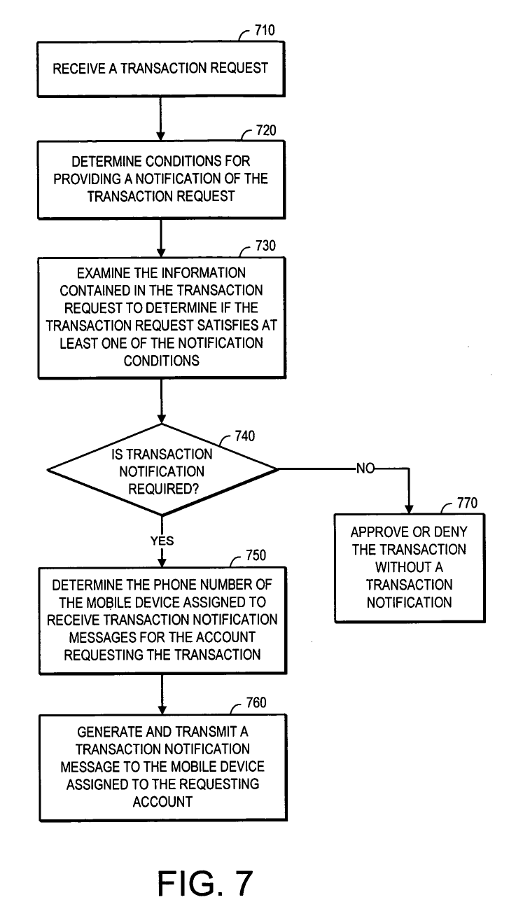

FIG. 7 shows general operations involved in providing conditional transaction notifications according to an embodiment of the present invention. The conditional notification process begins in block 710 by receiving a transaction request which includes information regarding the account requesting the transaction. When a transaction request is received, the notification conditions associated with the requesting account are read in block 720. In one embodiment, the same notification conditions may be applied to all accounts in the cardholder database 124. In another embodiment, a different set of notification conditions may be applicable to each individual accounts or a group of accounts. Before implementation of the conditional notification process, conditions for determining whether a transaction notification is required are associated with the accounts handled by the transaction authorization server 122. The notification conditions may be set for each individual account or on a set of accounts basis.

In block 730, a condition evaluation process is performed to determine if at least one of the notification conditions is satisfied. This may be accomplished by examining the applicable information contained in the transaction and comparing the applicable information with the notification conditions. Various notification conditions are contemplated by the inventor and are within the scope of the invention. In one implementation, one of the notification conditions may relate to the transaction amount stated in the transaction request. In this regard, the determination of whether a notification is required may involve examining a transaction amount indicated in the transaction request and comparing it with a predetermined amount. For example, a cardholder may not wish to receive notification messages when transactions involve less than a certain threshold amount (e.g., $50). To comply with the cardholder's wishes, the notification condition may be set such that transaction notification messages are provided only for transaction requests involving an amount greater than the threshold amount. And any transactions involving an amount less than the threshold amount will omit the process of generating and transmitting the notification message.

Another one of the notification conditions may relate to the merchant location stated in the transaction request. In this regard, the determination of whether a notification is required may involve examining the location of the merchant making the transaction request and comparing it with the address information of the cardholder. For example, notifications may be required for merchants that are located in a different country, state, city and/or region as the cardholder. Another one of the notification conditions may relate to the types of transaction. When transactions are made online, consumers are making the transactions by inputting information from a remote location, merchants cannot check for picture identification and/or compare the purchaser's signature with a signature on the transaction card to verify that the purchasers is an authorized cardholder. According, the system may be configured to require notification for transactions made online and/or from remote locations to notify the authorized cardholder of the pending transaction request. In this regard, the determination of whether a notification is required may involve receiving information from a payment server or merchant server that indicates if the transaction is being made online and/or from a remote location.

Another one of the notification conditions may relate to the amount of time lapsed since the most recent transaction request made by the requesting account. For example, if the requesting account has not made any transaction within a predetermined time (e.g., one month), then the card issuer may want to notify the cardholder of the current transaction request to reduce the risk of fraudulent charges. In this regard, the determination of whether a notification is required may involve examining the transaction history of the requesting account and determining when the most recent transaction was made. Another one of the notification conditions may relate to whether the requesting account has previously conducted a transaction with the same merchant submitting the transaction request. For example, if the cardholder is conducting a transaction with a merchant for the first time, then the card issuer may want to notify the cardholder of the current transaction request to reduce the risk of fraudulent charges. In this regard, the determination of whether a notification is required may involve examining the transaction history of the requesting account and determining if there is a record of a previous transaction between the requesting account and the merchant making the transaction request.

If it is determined that at least one of the notification conditions is satisfied (block 740, yes), then the notification process proceeds to block 750 to determine the phone number of the mobile device assigned to receive transaction notification messages for the account requesting the transaction. This may be accomplished by the phone number retrieving process 625 searching the cardholder information database 124 to find the record of the requesting account and to retrieve information regarding the phone number of the mobile device assigned to the requesting account. Then in block 760, the notification process proceeds to generate a text message which provides notification of the transaction request and transmits the notification message to the phone number of the mobile device assigned to the receive notification messages for the requesting account. On the other hand, if it is determined that a transaction notification is not required (block 740, no), then the transaction authorization server will complete the processing of the transaction request without notifying the cardholder of the transaction in block 770.

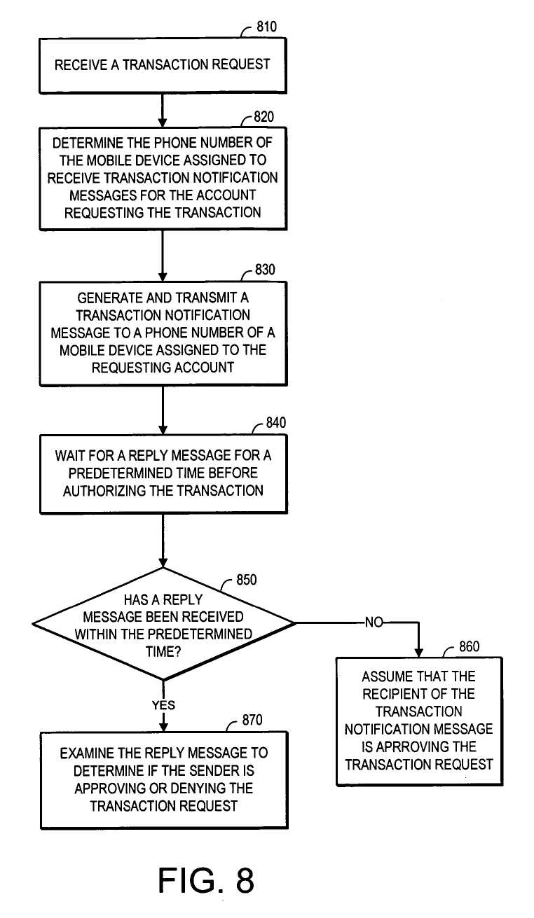

FIG. 8 shows general operations involved in processing a transaction request where a recipient has not replied to a transaction notification message according to an embodiment of the present invention. In one embodiment, if the recipient of a transaction notification message does reply within a predetermined time, the system assumes that the recipient is approving the transaction. In this embodiment, the system is configured to wait a defined period of time after it has transmitted a transaction notification message to a mobile device assigned to the requesting account. And if no reply message is received during that period of time, it is assumed that the cardholder is authorizing the transaction request. Once a transaction request is received by the transaction authorization server 122 in block 810, the server may perform various tasks to process the transaction request, including executing the transaction notification program 610 to provide a notification of the transaction request to an authorized cardholder via his or her assigned mobile device. The notification process begins in block 820 by determining the phone number of the mobile device assigned to the account requesting the transaction. This may be accomplished by the phone number retrieving process 625 searching the cardholder information database 124 to find the record of the requesting account and to retrieve information regarding the phone number of the mobile device assigned to the requesting account. Additionally, the transaction notification message generating process 630 is used to generate a text message to provide a notification of the pending transaction request in block 830. Once the transaction notification message has been generated, it is transmitted to the phone number of the mobile device assigned to the requesting account via a wireless network. In block 840, the program 610 is configured to wait for a reply message for a predetermined time before completing the transaction request. During the reply waiting period, if a reply message is received from the recipient of the transaction notification message, then the program 610 proceeds to block 870 to examine the reply message to determine if the sender is explicitly approving or denying the transaction. At the end of the reply waiting period, the program 610 checks to determine whether there has been a reply to the transaction notification message in block 850. The lapse of the reply waiting period may be determined based on the time of message transmission information 654 contained the pending transaction database 123. The determination of whether there has been a reply to the transmitted notification message may be determined based on the status information 255 contained in the pending transaction database 123. If a reply message has not been received within the reply waiting period (block 850, no), then the program 610 proceeds to block 860 and assumes that the recipient of the transaction notification message is approving the transaction request. Accordingly, if the recipient fails to reply to the transaction notification message before the expiration of the reply waiting period, the server 122 will complete the processing of the transaction request (i.e., approve or deny the transaction request) without further waiting for a reply from the mobile device assigned to the requesting account.

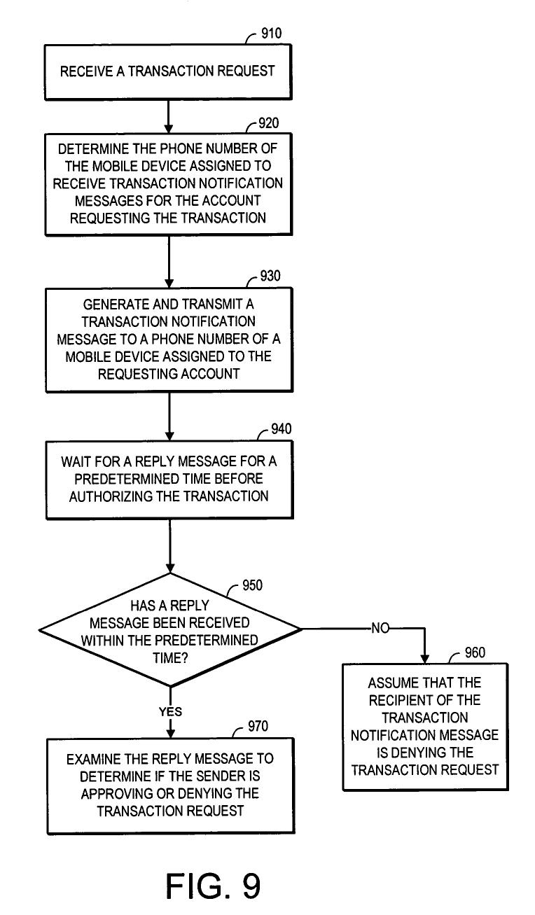

FIG. 9 shows general operation involved in processing a transaction request where a recipient has not replied to a transaction notification message according to another embodiment of the present invention. In this embodiment, if the recipient of a transaction notification message does reply within a predetermined time, the system assumes that the recipient is denying the transaction. Accordingly, in this embodiment, the system is configured to wait a defined period of time after it has transmitted a transaction notification message to a mobile device assigned to the requesting account. And if no reply message is received during that period of time, it is assumed that the cardholder is denying the transaction request (block 960).

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A method comprising:
receiving a transaction request which includes information regarding an account requesting a transaction;
determining if the transaction request satisfies at least one condition for providing a transaction notification; and
transmitting a transaction notification message to a communication device assigned to the requesting account if at least one condition for providing the notification is satisfied by the transaction request.

2. The method of claim 1, further comprising:
specifying at least one condition for providing a transaction notification;
associating the at least one condition to one or more accounts issued by a card issuer;
responsive to receiving a transaction request, recognizing one or more conditions associated with the account requesting the transaction; and
responsive to determination that the transaction request satisfies the at least one condition fro providing a transaction notification, generating a transaction notification message based on information contained in the transaction request.

3. The method of claim 1, wherein determining if the transaction request satisfies at least one condition comprises:
examining a transaction amount indicated in the transaction request; and
comparing the transaction amount with a predetermined amount.

4. The method of claim 1, wherein determining if the transaction request satisfies at least one condition comprises:
determining a location of a merchant making the transaction request.

5. The method of claim 1, wherein determining if the transaction request satisfies at least one condition comprises:
determining if the transaction request is made online.

6. The method of claim 1, wherein determining if the transaction request satisfies at least one condition comprises:
determining an amount of time lapsed since a most recent transaction request made by the requesting account.

7. The method of claim 1, wherein determining if the transaction request satisfies at least one condition comprises:
determining if the requesting account has previously conducted a transaction with a merchant making the transaction request.

8. The method of claim 1, further comprising:
after transmitting of the transaction notification message, authorizing the transaction request if a reply message from the communication device is not received within a predetermined time.

9. The method of claim 1, further comprising:
after transmitting of the transaction notification message, denying the transaction request if a reply message from the communication device is not received within a predetermined time from the communication device.

10. The method of claim 1, further comprising:
receiving a reply message from the communication device assigned to the account requesting the transaction; and
examining the reply message received from the communication device to determine if the user of the communication device explicitly approves or denies the transaction request.

11. A method comprising:
receiving a transaction request which includes information regarding an account requesting a transaction; and
determining a phone number of a mobile device assigned to receive transaction notification messages for the account requesting the transaction;
generating a transaction notification message based on information contained in the transaction request;
transmitting the transaction notification message to the phone number of the mobile device assigned to the account requesting the transaction; and
waiting a defined period of time to receive a reply message from the mobile device assigned to the account requesting the transaction.

12. The method of claim 11, further comprising:
authorizing the transaction request if the reply message is not received within the defined period of time.

13. The method of claim 11, further comprising:
denying the transaction request if the reply message is not received within the defined period of time.

14. The method of claim 11, further comprising:
receiving a reply message from the mobile device assigned to the account requesting the transaction; and
examining the reply message to determine if the user of the mobile device explicitly approves or denies the transaction request.

15. The method of claim 11, further comprising:
determining if a transaction notification is required to process the transaction request based on whether at least one notification condition is satisfied by the transaction request.

16. The method of claim 15, wherein determining if a transaction notification is required comprises:
examining a transaction amount indicated in the transaction request; and
comparing the transaction amount with a predetermined amount.

17. The method of claim 11, wherein the transaction request is received from one of following sources: (i) an online merchant server, (ii) a payment server, (iii) an automatic teller machine (ATM), (iv) a point of sale (POS) terminal and (v) a credit card terminal.

18. The method of claim 11, wherein the transaction notification message is a text message containing following information: (i) a purchase description, (ii) a purchase amount, and (iii) a date of the transaction.

19. A system comprising:
a transaction processing system coupled to receive transaction requests, each transaction request including information regarding an account requesting a transaction;
a plurality of mobile devices capable of establishing communication with the transaction processing system via a wireless network, each of the mobile devices having a phone number; and
a first database coupled to the transaction processing system to store a plurality of account records, at least one of the account records including: (i) an account number and (ii) a phone number of a mobile device assigned to receive transaction notification messages,
wherein the transaction processing system to determine a phone number of a mobile device assigned to receive transaction notification messages for an account requesting a transaction by searching the first database, the transaction processing system to determine if a transaction request satisfies at least one condition for providing a notification of the transaction request and to transmit a transaction notification message to the phone number of the mobile device assigned to the requesting account if at least one condition for providing the notification is satisfied by the transaction request.

20. The system of claim 19, wherein the transaction processing system is configured to associate at least one condition for providing a transaction notification to one or more account issued by a card issuer and, responsive to receiving a transaction request, the transaction processing system is configured to recognize a condition associated with the account requesting transaction.

21. The system of claim 19, wherein the transaction processing system is configured to determine if the transaction request satisfies at least one condition by examining a transaction amount indicated in the transaction request; and comparing the transaction amount with a predetermined amount.

22. The system of claim 19, wherein the transaction processing system is configured to determine if the transaction request satisfies at least one condition by determining if the transaction request was initiated by a consumer from a remote location.

23. The system of claim 19, wherein the transaction processing system is configured to receive a reply message from the mobile device assigned to the account requesting the transaction and to examine the reply message to determine if the user of the mobile device explicitly approves or denies the transaction request.

24. The system of claim 19, wherein the transaction processing system is configured to authorize the transaction request if a reply message is not received within a predetermined time from the mobile device assigned to the requesting account.

25. The system of claim 19, wherein the transaction processing system is configured to deny the transaction request if a reply message is not received within a predetermined time from the mobile device assigned to the requesting account.
